(19) United States
(12) Patent Application Publication
(10) Pub. No.: US 2011/0240786 A1
(43) Pub. Date: Oct. 6, 2011

(54) MANUFACTURING METHOD OF REEL, REEL, AND RECORDING TAPE CARTRIDGE

(75) Inventor: Kenji TAKENOSHITA, Kanagawa (JP)

(73) Assignee: FUJIFILM CORPORATION, Tokyo (JP)

(21) Appl. No.: 13/047,745

(22) Filed: Mar. 14, 2011

(30) Foreign Application Priority Data
Mar. 30, 2010 (JP) 2010-079880

(51) Int. Cl. G11B 23/113; B29C 45/14; B65H 75/18; B65H 75/14; G11B 23/107

(52) U.S. Cl. 242/348.3; 264/104; 242/610.4; G9B/23.078

(57) ABSTRACT

A manufacturing method of a reel including a substantially cylindrical hub, around an outer peripheral surface of which a recording tape is wound, and flanges provided at end portions of the hub, includes entering a pelletized resin material and a fibrous conductive material whose length is longer than a pellet length of the resin material into a molding machine to mold the hub and the flanges, thereby providing conductivity to the hub and the flanges.

### CROSS-REFERENCE TO RELATED APPLICATION

This application claims priority under 35 USC 119 from Japanese Patent Application No. 2010-079880 filed Mar. 30, 2010, the disclosure of which is incorporated by reference herein.

### BACKGROUND OF THE INVENTION

1. Field of the Invention

The present invention relates to a manufacturing method of a reel on which a recording tape such as a magnetic tape, mainly used as recording/playback media of a computer or the like, is wound, the reel, and a recording tape cartridge.

2. Related Art

A recording tape cartridge in which a recording tape such as a magnetic tape, which is used as data recording/playback media (data backup) of a computer or the like, is wound on a synthetic resin reel and the single reel is accommodated in a case has been conventionally known. A capacity of such recording tape cartridge is required to be higher. Along therewith, a sensitivity of a magnetoresistive element configuring a recording/playback head of a drive device tends to be improved.

Meanwhile, at a time in which the recording tape cartridge is loaded into the drive device and the recording tape is drawn out from the reel to run, an edge of the recording tape is frictionally slid on a flange of the reel thereby the recording tape is frictionally electrified (charged). In a case in which the frictionally electrified recording tape is brought into contact with the recording/playback head (magnetoresistive element) whose sensitivity is improved, the recording/playback head (magnetoresistive element) may be damaged by electro static discharge (hereinafter, called “ESD”).

For this reason, there has been conventionally proposed a magnetic tape cartridge having a reel which is molded of a synthetic resin material to which a conductive filler is added (for example, see Japanese Patent Application Laid-Open (JP-A) No. 2003-223774). According to the reel, since frictional electrification of a recording tape is inhibited, damage of a recording/playback head (magnetoresistive element) whose sensitivity is improved may be avoided.

However, the reel described in JP-A No. 2003-223774 is manufactured by a typical molding method in which: a resin pellet to which a conductive filler is added in advance is entered into a molding machine; the resin pellet is melted; and the reel is then molded of the melted resin material containing the conductive filler. Therefore, a flowability of the resin material in a metal mold for molding become worse due to the conductive filler, with the result that, as compared with a case in which the reel is molded of the resin material to which the conductive filler is not added, the size is changed. For this reason, in manufacturing the reel which is required precision, there is the disadvantage that a design of the metal mold need be changed.

### SUMMARY OF THE INVENTION

In view of the above circumstances, the invention is to provide a manufacturing method of a reel which can secure a flowability in a mold at manufacturing of the reel having conductive characteristic, the reel, and a recording tape cartridge.

A manufacturing method of a reel according to a first aspect of the invention, the reel including a substantially cylindrical hub, around an outer peripheral surface of which a recording tape is wound, and flanges provided at end portions of the hub, includes: entering a pelletized resin material and a fibrous conductive material whose length is longer than a pellet length of the resin material into a molding machine to mold the hub and the flanges, thereby providing conductivity to the hub and the flanges.

According to the first aspect of the invention, the pelletized resin material and the fibrous conductive material whose length is longer than the pellet length of the resin material are together entered into the molding machine. In other words, in the invention, the pelletized resin material into which the fibrous conductive material is mixed in advance is not entered into the molding machine. Therefore, the length of the fibrous conductive material can be longer than the pellet length of the pelletized resin material. So, in the present invention, with a lesser number of the fibrous conductive materials, the same conductivity in a case in which the reel is molded from a pelletized resin material into which fibrous conductive materials with the number are mixed in advance can be applied to the reel. In other words, according to the invention, the number of the fibrous conductive materials mixed into the melted resin material can be smaller than the conventional art. Thus, there is not the disadvantage that a flowability of the melted resin material in the metal mold becomes worse by the conductive materials, so that the flowability can be secured.

In the manufacturing method of the reel according to a second aspect, in the manufacturing method of the reel according to the first aspect, as the conductive material, a copper plated aramid fiber is used.

According to the second aspect of the invention, since the copper plated aramid fiber is soft, there is not the disadvantage that the flowability of the melted resin material in the metal mold becomes worse by the copper plated aramid fiber, so that the flowability can be sufficiently secured.

In the first and the second aspect, it is preferable that the resin material entered into the molding machine does not contain therein a conductive material.

A reel according to a third aspect of the invention is a reel manufactured by the manufacturing method of the reel accrding to the first or second aspect, in which a metal reel plate is fixed to a bottom portion outer surface of the hub.

According to the third aspect of the invention, frictional electrification (static electricity) caused by frictional sliding of the recording tape on the flange(s) can be released, not only from the flange(s), but also from the reel plate. In other words, the reel plate may be a ground of the recording tape.

A recording tape cartridge according to a fourth aspect of the invention includes a reel according to the third aspect on which a recording tape is wound; a case which accommodates the single reel; and a leader member which is attached to a free end portion of the recording tape and is drawable out from an opening formed in the case.

According to the fourth aspect of the invention, even if the recording tape cartridge is loaded into a drive device and the recording tape is drawn out from the reel so as to be driven, frictional electrification of the recording tape can be suppressed. Therefore, even if a sensitivity of a recording/playback head of the drive device is improved, the recording/playback head can not be damaged.

As described above, according to the invention, a manufacturing method of a reel which can secure a flowability in a metal mold at manufacturing of the reel having conductive characteristic, the reel, and a recording tape cartridge may be provided.

### BRIEF DESCRIPTION OF THE DRAWINGS

Embodiments of the invention will be described in detail with reference to the following figures, wherein:

FIG. 1 is a schematic perspective view of a recording tape cartridge;

FIG. 2 is a schematic exploded perspective view of the recording tape cartridge as seen from above;

FIG. 3 is a schematic exploded perspective view of the recording tape cartridge as seen from below;

FIG. 4 is a schematic exploded cross-sectional view of a reel to which a conductivity is provided;

FIG. 5 is a schematic cross-sectional view of the reel to which a conductivity is provided;

FIG. 6 is a schematic perspective view showing the comparison of a resin pellet and a conductive filler;

FIG. 7 is a schematic perspective view showing a molding machine into which the resin pellets and the conductive fillers are introduced;

FIG. 8 is a schematic cross-sectional view showing a state that a resin material containing the conductive filler according to this example is injected into a mold; and

FIG. 9 is a schematic cross-sectional view showing a state that a resin material containing a conductive filler according to a comparative example is injected into the mold.

### DETAILED DESCRIPTION OF THE INVENTION

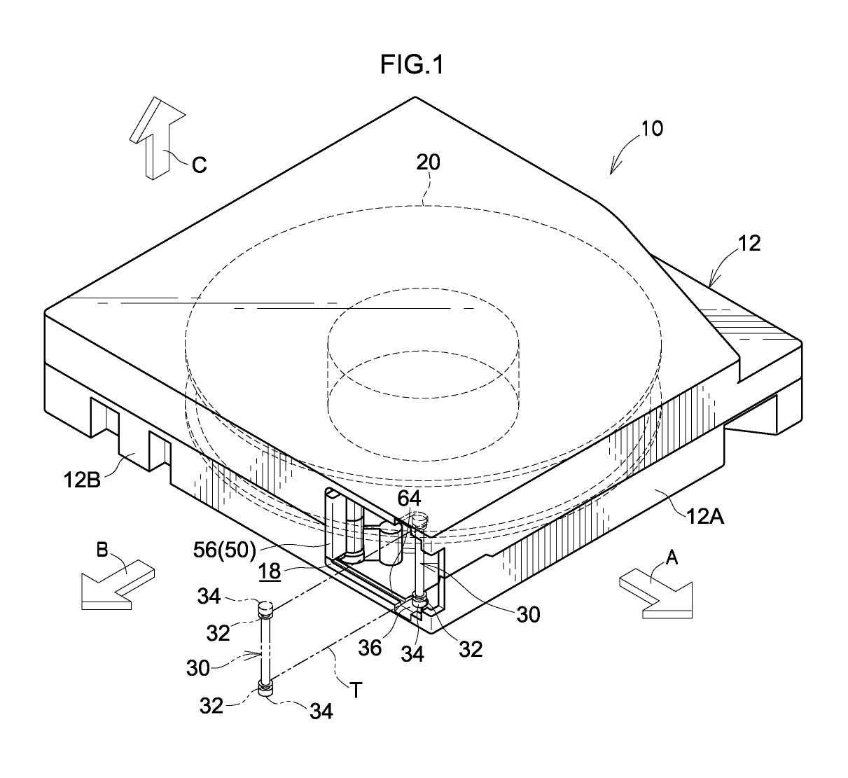

The exemplary embodiment of the invention will be described below in detail based on examples shown in the figures. Meanwhile, for convenience of description, a direction of loading a recording tape cartridge 10 into a drive device is indicated by an arrow A, as shown in FIG. 1, so that the arrow A is a forward direction (front side) of the recording tape cartridge 10. Also, a direction orthogonal to the arrow A direction is indicated by an arrow B, so that the arrow B is a rightward direction (right side) of the recording tape cartridge 10. In addition, a direction orthogonal to the arrow A direction and the arrow B direction is indicated by an arrow C, so that the arrow C is an upward direction (upper side) of the recording tape cartridge 10. First, the recording tape cartridge 10 will be described.

As shown in FIGS. 1 to 3, the recording tape cartridge 10 has a case 12 formed into a substantially rectangular box shape. The case 12 is formed by joining an upper case 14 and a lower case 16 made of a resin such as polycarbonate (PC) together by ultrasonic welding or screwing, in a state in which a peripheral wall 14B disposed along a peripheral edge of a top plate 14A in a standing manner and a peripheral wall 16B disposed along a peripheral edge of a bottom plate 16A in a standing manner abut each other.

In other words, for example, screw bosses 15 are formed near respective corner portions of the upper case 14 and the lower case 16, and a screw, not shown, is screwed into the screw boss 15 from a lower surface side of the lower case 16 so as to assemble the case 12. In addition, only single reel 20 is rotatably accommodated in the case 12.

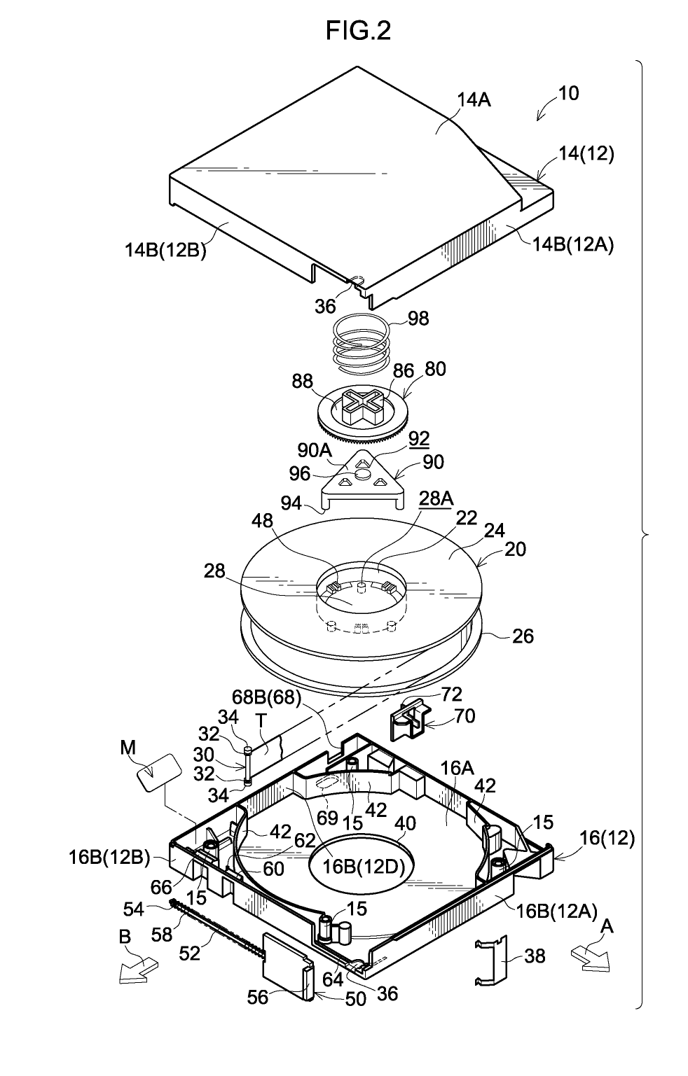

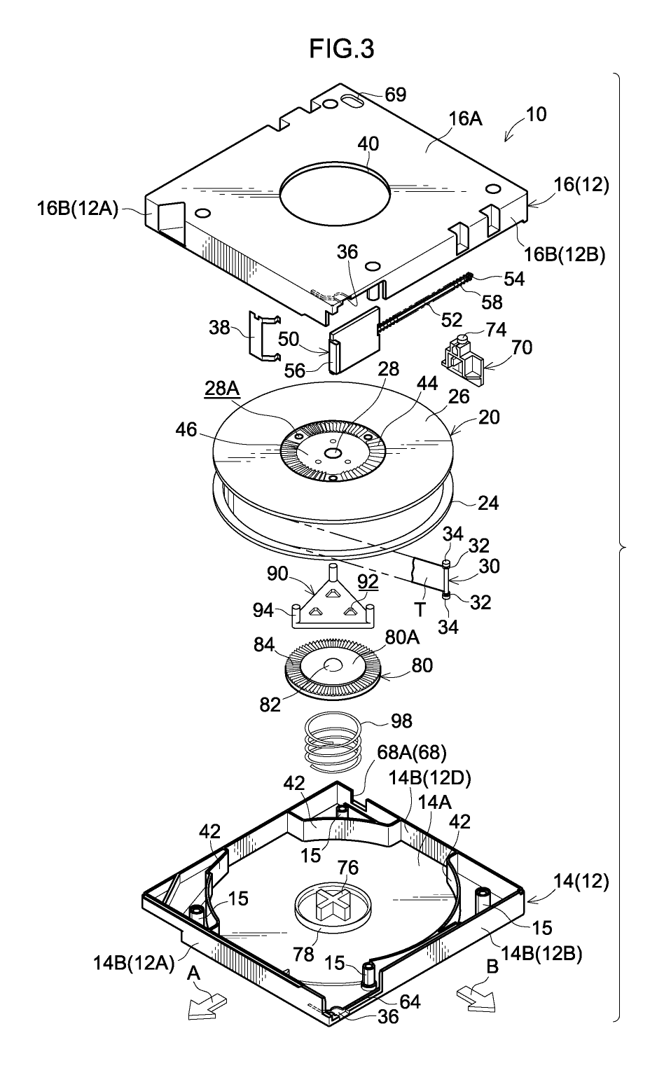

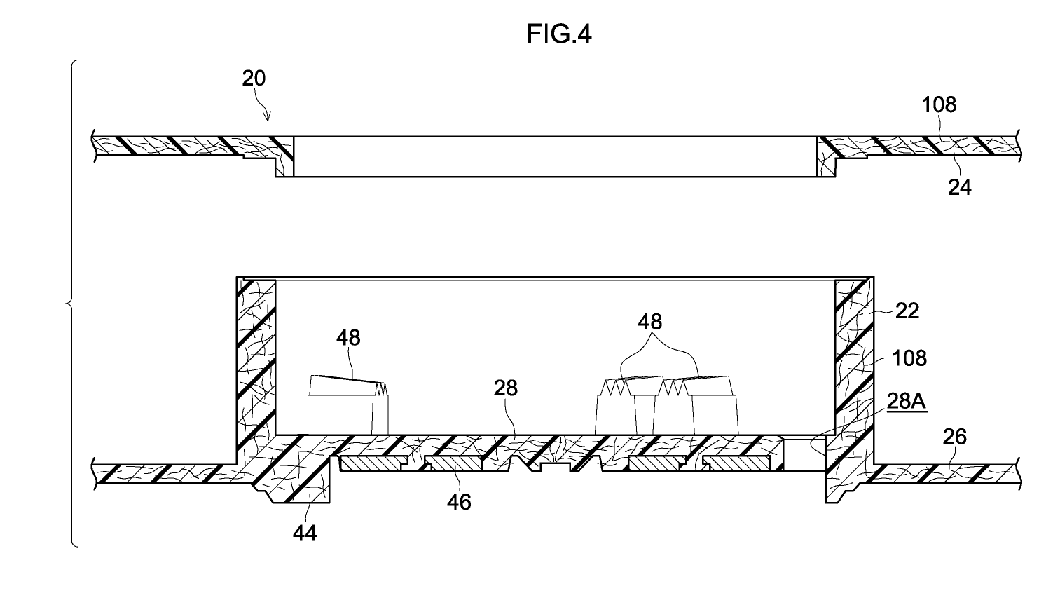

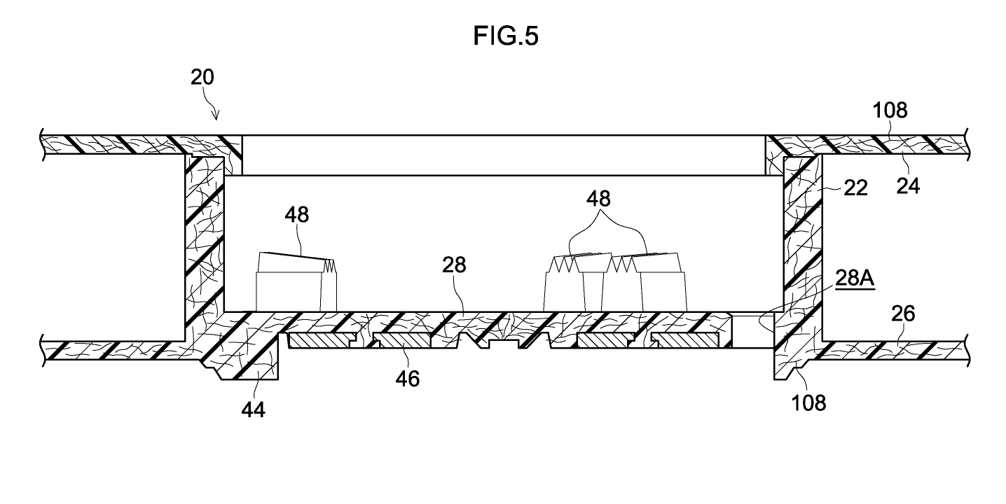

As shown in FIGS. 4 and 5, in the reel 20, a bottomed cylindrical reel hub 22 forming an axial portion and a lower flange 26 provided in a lower end portion of the reel hub 22 are integrally molded, and an upper flange 24 is ultrasonically welded to an upper end portion of the reel hub 22. Also, as shown in FIGS. 2 and 3, a recording tape T such as a magnetic tape is wound as an information recording/playback medium on an outer peripheral surface of the reel hub 22, and width direction both end portions (hereinafter, mentioned as “edges”) of the wound recording tape T are held by the upper flange 24 and the lower flange 26, respectively.

The reel 20 also has a conductivity. In other words, a later-described fibrous conductive material 108 is mixed into a resin material which molds the reel hub 22 and the lower flange 26, and the upper flange 24. Therefore, even if the edge of the recording tape T are frictionally slid on an inner surface of the upper flange 24 or an inner surface of the lower flange 26, frictional electrification (charging) of the recording tape T can be suppressed.

Also, as shown in FIG. 3, a reel gear 44 is annually formed on a lower surface (outer surface) of a bottom wall (bottom portion) 28 of the reel hub 22, and a gear opening 40 for exposing the reel gear 44 to an outside is opened in a center portion of the lower case 16. The reel gear 44 exposed from the gear opening 40 is meshed with a driving gear (not shown) formed on a rotational shaft (not shown) of the drive device and is rotationally driven, so that the reel 20 can be relatively rotatable with respect to the case 12 inside the case 12.

Also, a reel plate 46 which is an annular metal plate made of a magnetic material is coaxially and integrally fixed to radius direction inside portion of the reel gear 44 on the lower surface of the bottom wall 28 by insert molding. The reel plate 46 is absorbed and held by a magnetic force of an annular magnet (not shown) provided on the rotational shaft of the drive device. Further, the reel 20 is held by play regulation walls 42, which are provided in partially projected manner at inner surfaces of the upper case 14 and the lower case 16, respectively, and which are as inner walls provided on a circular track coaxial with the gear opening 40, so as not to be rattled.

Also, as shown in FIGS. 1 to 3, an opening 18 for drawing out the recording tape T wound on the reel 20 is formed in a right wall 12B of the case 12, and a leader pin 30 as a leader member drawably operated while caught (engaged) by a drawing member (not shown) of the drive device is fixed to a free end portion of the recording tape T drawn out from the opening 18. Annular grooves 32 are formed at both end portions of the leader pin 30 projected from the end portions in the width direction of the recording tape T, and are engaged with a hook or the like of the drawing member.

Also, a pair of upper and lower pin holding portions 36 which position and hold the leader pin 30 in the case 12 are provided inside the opening 18 of the case 12, that is, on an inner surface of the top plate 14A of the upper case 14 and an inner surface of the bottom plate 16A of the lower case 16. The pin holding portions 36 have a substantially semicircular shape and in which a side of drawing out the recording tape T is opened, and both end portions 34 of the upright leader pin 30 in a stand state can enter into or exit from the pin holding portions 36 from an opened side thereof.

Also, a plate spring 38 is fixedly arranged near the pin holding portions 36, and two-forked tip end portions of the plate spring 38 are engaged with the upper and lower both end portions 34 of the leader pin 30, respectively, to hold the leader pin 30 into the pin holding portions 36. Meanwhile, at a time in which the leader pin 30 enters into or exits from the pin holding portions 36, the tip end portions of the plate spring 38 are resiliently deformed, if necessary, to allow the movement of the leader pin 30.

Also, the opening 18 is opened and closed by a door 50. The door 50 is formed into a substantially rectangular plate shape of a size which can close the opening 18, and, in order that the door 50 is movable along the right wall 12B of the case 12, groove portions 64 which slidably fit upper and lower ends of the door 50 thereinto are formed to the top plate 14A and the bottom plate 16A inside the opening 18.

Also, a shaft 52 is provided in a projected manner from a rear end portion center of the door 50, and a coil spring 58 is insertably fitted into the shaft 52. An enlarged portion 54 which prevents the coil spring 58 from being fallen is formed at a rear end of the shaft 52. A support base 60 having an catching portion 62 which latches a rear end of the coil spring 58 insertably fitted into the shaft 52 is projected-provided from the lower case 16.

Therefore, the shaft 52 is slidably supported on the support base 60, and the rear end of the coil spring 58 is caught with the catching portion 62, so that an urging force of the coil spring 58 urges the door 50 in a closing direction of the opening 18 at all times. Further, a support base 66 which supports the shaft 52 at a time in which the opening 18 is opened, is preferably projected-provided on a rear side of the support base 60.

Also, a convex portion 56 for an opening and closing operation is projected outward from a front end portion of the door 50. Along with loading of the recording tape cartridge 10 into the drive device, the convex portion 56 is engaged with an opening and closing member (not shown) of the drive device side. From this, the door 50 is opened against the urging force of the coil spring 58.

Also, as shown in FIGS. 2 and 3, a write protect 70 in which record enabling or record disabling to the recording tape T is set is provided in a left rear portion of the case 12 so as to be slidable in right and left directions, and an opening hole 68 from which projects an operation projection 72 for manually operating the write protect 70 is formed in a rear wall 12D of the case 12. At the upper case 14 and the lower case 16 being joined, the opening hole 68 is formed by a notch portion 68A formed in the peripheral wall 14B of the upper case 14 and a notch portion 68B formed in the peripheral wall 16B of the lower case 16.

Further, a long hole 69 from which a projection portion 74 of the write protect 70 is exposed is opened in the lower case 16 so as to be long in the right and left directions, and at a time in which the recording tape cartridge 10 is loaded into the drive device, at the side of the drive device, a position of the write protect 70 is detected to automatically judge record enabling or record disabling to the recording tape T. Further, the projection portion 74 is not projected from the lower surface of the lower case 16. As shown in FIG. 2, a memory board M which stores various kinds of information such as a recording capacity and a recording form is arranged at a predetermined inclination angle in a right rear portion of the case 12.

Also, as shown in FIGS. 2 and 3, plural (e.g., three at an interval of 120 degrees) engaging gears 48 are disposed in a standing manner so as to be spaced at a predetermined interval (equally spaced) along an upper surface peripheral edge portion of the bottom wall 28 of the reel hub 22, and plural (in this case, three at an interval of 120 degrees) through-holes 28A are opened in predetermined positions on the reel gear 44 between the engaging gears 48. In addition, a disc-like braking member 80 molded of a resin material is inserted and provided into the reel hub 22.

A breaking gear 84 which is engageable with the engaging gears 48 is annually formed along a peripheral edge portion of a lower surface 80A of the breaking member 80, and an engaging projection 86 which has a substantially cross shape in plan view and into which a rotation regulation rib 76 which has a substantially cross shape in plan view and is projected downward from the inner surface of the top plate 14A of the upper case 14 is inserted therein, is disposed in standing manner on an upper surface of the breaking member 80 so as to be slightly higher than the height of the rotation regulation rib 76. From this, the breaking member 80 is unrotatable with respect to the case 12 (upper case 14), and is movable in upper and lower direction in the reel hub 22.

Also, a compression coil spring 98 is disposed between the upper case 14 and the breaking member 80. In other words, the compression coil spring 98 is disposed in a state that one end thereof is abutted onto an inside of an annular projection 78 provided and projected at an outside of the rotation regulation rib 76 of the upper case 14 (between the rotation regulation rib 76 and the annular projection 78), and the other end thereof is abutted into an annular groove 88 provided on the upper surface of the breaking member 80. An urging force of the compression coil spring 98 urges the braking member 80 downward at all times.

Therefore, at a time in which the recording tape cartridge 10 is not used (or is not loaded into the drive device), the breaking gear 84 is meshed with the engaging gears 48 at all times, and the reel 20 is brought into a rotation lock state in which the relative rotation of the reel 20 with respect to the case 12 is inhibited. The reel 20 is pressed onto the lower case 16 side by the urging force to expose the reel gear 44 from the gear opening 40.

Also, a releasing member 90 which is molded of a resin material and has a substantially regular triangular shape in plan view is inserted-provided inside the reel hub 22 and on a lower side of the breaking member 80 (between the bottom wall 28 and the braking member 80). Plural (three) through-holes 92 having a predetermined shape are opened in appropriate positions of the releasing member 90, so that the weight of the releasing member 90 is reduced. Leg portions 94 which are inserted through the through-holes 28A and are projected from a lower surface of the bottom wall 28 onto the reel gear 44 by a predetermined height, are projected from apex portions of a lower surface of the releasing member 90.

Also, a center of an upper surface 90A of the releasing member 90 is formed with a planar support convex portion 96 onto which a substantially semispherical releasing projection 82 projected from a center of the lower surface 80A of the breaking member 80 is abutted (see FIGS. 2 and 3). From this, a contact area of the breaking member 80 and the releasing member 90 is reduced to reduce sliding resistance in use (at the time of rotation of the reel 20). Further, as a material of the breaking member 80, for example, polyacetal (POM) is used, and a material of the releasing member 90, for example, polybutylene terephthalate (PBT) is used.

Next, an operation of the recording tape cartridge 10 having the above configuration will be described. At a time in which the recording tape cartridge 10 is not used (for example, the recording tape cartridge 10 is stored or is conveyed), the opening 18 of the recording tape cartridge 10 is closed by the door 50. Then, by the urging force of the compression coil spring 98, the breaking member 80 is located in a rotation lock position so as to mesh (engage) the breaking gear 84 with the engaging gears 48. For this reason, the rotation of the reel 20 with respect to the case 12 is inhibited.

At a time in which the recording tape T is used, the recording tape cartridge 10 is loaded into the drive device along the arrow A direction from the front wall 12A of the recording tape cartridge 10. First, the opening and closing member provided on the drive device side is engaged with the convex portion 56 of the door 50. Then, in this state, when the recording tape cartridge 10 is further moved in the arrow A direction, the opening and closing member moves the convex portion 56 relatively rearward against the urging force of the coil spring 58. Then, the door 50 from which the convex portion 56 is projected is slid rearward in the groove portions 64 along the right wall 12B to open the opening 18.

In this way, the recording tape cartridge 10 is loaded into the drive device by a predetermined depth to completely open the opening 18, the recording tape cartridge 10 is lowered by a predetermined height, and a positioning member (not shown) of the drive device is inserted into a positioning hole portion (not shown) formed in the lower case 16. Thereby the recording tape cartridge 10 is precisely positioned in a predetermined position in the drive device, and regulating further sliding (movement to the rear side) of the door 50.

Also, by the lowering action of the recording tape cartridge 10, the rotational shaft relatively enters from the gear opening 40 to engage the driving gear with the reel gear 44. Then, with the action of engaging the driving gear with the reel gear 44, the leg portions 94 projected onto the reel gear 44 are pushed up against the urging force of the compression coil spring 98, and the braking member 80 is pushed up via the releasing member 90 to release the engagement of the braking gear 84 and the engaging gears 48.

Then, in a state that the driving gear and the reel gear 44 are completely meshed, the reel plate 46 is absorbed and held by the magnetic force of the annular magnet provided inside the driving gear, so that the reel 20 is brought into a lock release state in which the reel 20 is relatively rotatable with respect to the case 12 inside the case 12 while the mesh of the reel gear 44 with respect to the driving gear is maintained.

On the other hand, the drawing member provided on the drive device side enters into the case 12 from the opened opening 18 to hold and draw out the leader pin 30 positioned and held by the pin holding portions 36. Further, at this time, since the recording tape cartridge 10 is precisely positioned in the drive device, the drawing member can reliably engage the hooks with the annular grooves 32 of the leader pin 30. In addition, the reel 20 whose rotation lock state is released may be rotated with a drawing operation of the leader pin 30.

Thus, the leader pin 30 drawn out from the opening 18 is accommodated in a winding reel, not shown. Then, the winding reel and the reel 20 are rotationally synchronously driven, so that the recording tape T is sequentially drawn out from the case 12 while wound on the winding reel and recording and playing back of information is performed by a recording/playback head (not shown) disposed along a predetermined tape path.

Further, at this time, the edges of the recording tape T are frictionally slid on the inner surface of the upper flange 24 and the inner surface of the lower flange 26 of the reel 20 and are frictionally electrified (charged) (static electricity charged). However, since the reel 20 has a conductivity, the static electricity can be released to the reel plate 46 via the reel hub 22, the upper flange 24 and the lower flange 26. In other words, the upper flange 24, the lower flange 26, and the reel plate 46 can be a ground of the recording tape T.

Therefore, frictional electrification is suppressed in the recording tape T which runs along the predetermined tape path, and even if a sensitivity of a magnetoresistive element (not shown) configuring the recording/playback head is improved along with the higher capacity of the recording tape cartridge 10, the magnetoresistive element (recording/playback head) can not be damaged by ESD.

At a time in which the recording tape cartridge 10 which completes information recording and/or playback is ejected from the drive device, first, the rotational shaft is reversely rotated to rewind the recording tape T on the reel 20. Then, the recording tape T is completely rewound on the reel 20, and the leader pin 30 is held by the pin holding portions 36, so the recording tape cartridge 10 is lifted by the predetermined height, the positioning member is pulled out from the positioning hole portion, the rotational shaft is pulled out from the gear opening 40, and the mesh of the driving gear with the real gear 44 is released.

Then, the urging force of the compression coil spring 98 presses the braking member 80 and the releasing member 90 downward, the leg portions 94 are inserted through the through-holes 28A so as to be projected from the lower surface of the bottom wall 28 onto the reel gear 44 by the predetermined height, and the braking gear 84 is meshed with the engaging gears 48. By this, the reel 20 is brought again into the rotation lock state in which the relative rotation in the case 12 is inhibited, and thereafter, the recording tape cartridge 10 is moved in the opposite direction of the arrow A direction by an eject mechanism, not shown.

Then, along with this movement, the door 50 is slid in the closing direction of the opening 18 by the urging force of the coil spring 58 to completely close the opening 18 (or to return into the initial state). Thus, the relative rotation of the reel 20 with respect to the case 12 is locked, so that the recording tape cartridge 10 in which the opening 18 is closed is completely ejected from an interior of the drive device.

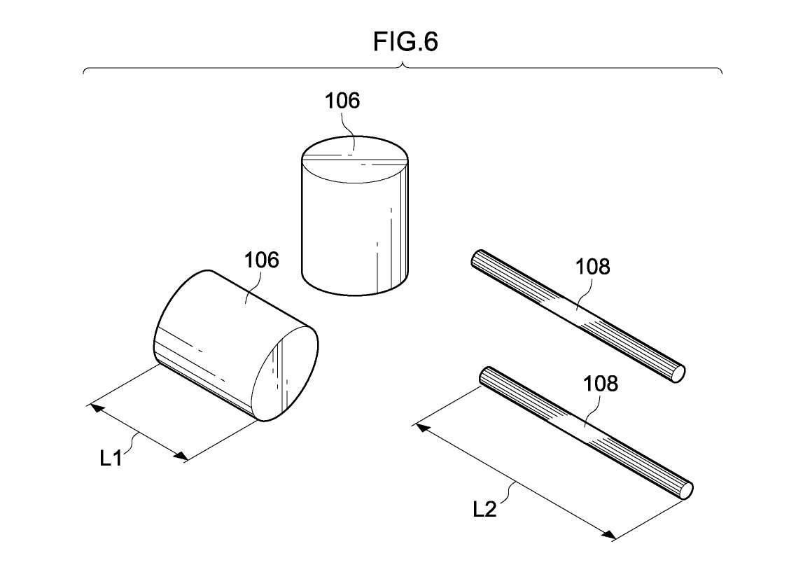

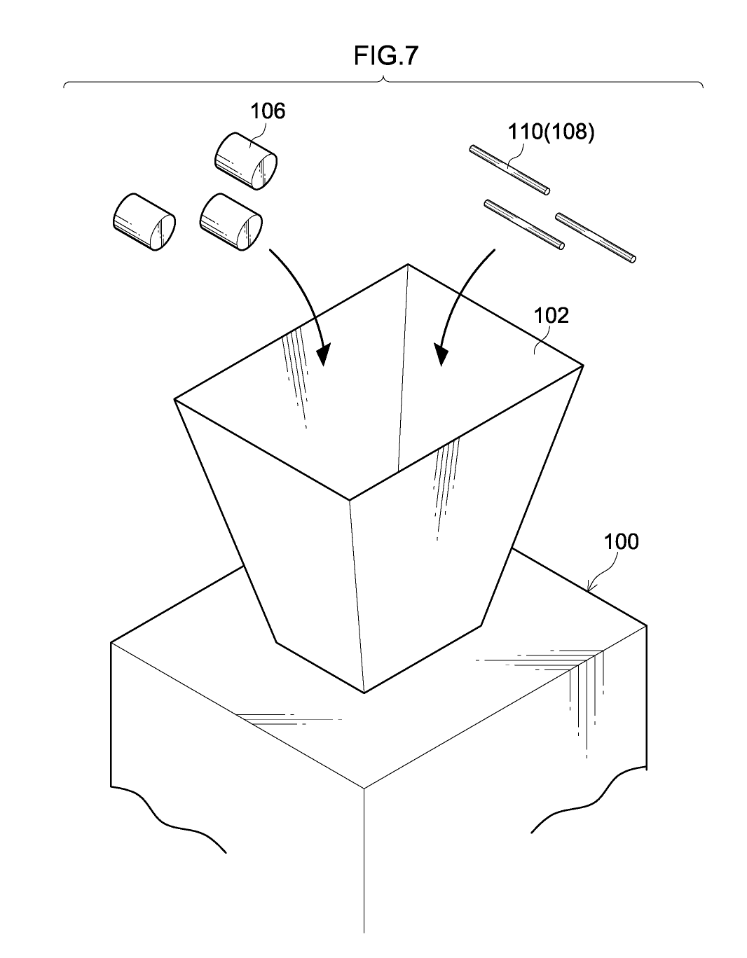

In the above recording tape cartridge 10, a manufacturing method of the reel 20 having a conductivity will be described hereinafter. As shown in FIGS. 6 and 7, in the manufacturing method of the reel 20 according to this exemplary embodiment, a pellet resin material (hereinafter, called a “resin pellet”) 106 and a fibrous conductive member 110 including the fibrous conductive material (hereinafter, called a “conductive filler”) 108 having a length L2 which is longer than a pellet length (or a pellet height of the resin pellet 106 formed into a substantially cylindrical shape in the drawing) L1 of the resin pellet 106 are entered from an input port 102 into an injection molding machine 100.

Note that the pellet length L1 corresponds to the maximum length of the resin pellet 106.

In other words, in the manufacturing method of the reel 20 according to this exemplary embodiment, in the molding process of the reel 20 (the reel hub 22, the lower flange 26 integral with the reel hub 22, and the upper flange 24 which is to be welded or fused onto the reel hub 22), a resin pellet into which the conductive filler(s) is mixed in advance (manufactured by mixing with the conductive filler(s)) (not shown) is not entered into the injection molding machine 100, but the resin pellet 106 into which the conductive filler(s) is not mixed and the conductive filler member 110 are entered into the injection molding machine 100.

Here, in the exemplary embodiment, for example, plural conductive fillers 108 having a length L2 are bound (bundled) to form one rod shaped conductive filler member 110 having a length L2, that is, three rod shaped conductive filler members 110 are shown in FIG. 7.

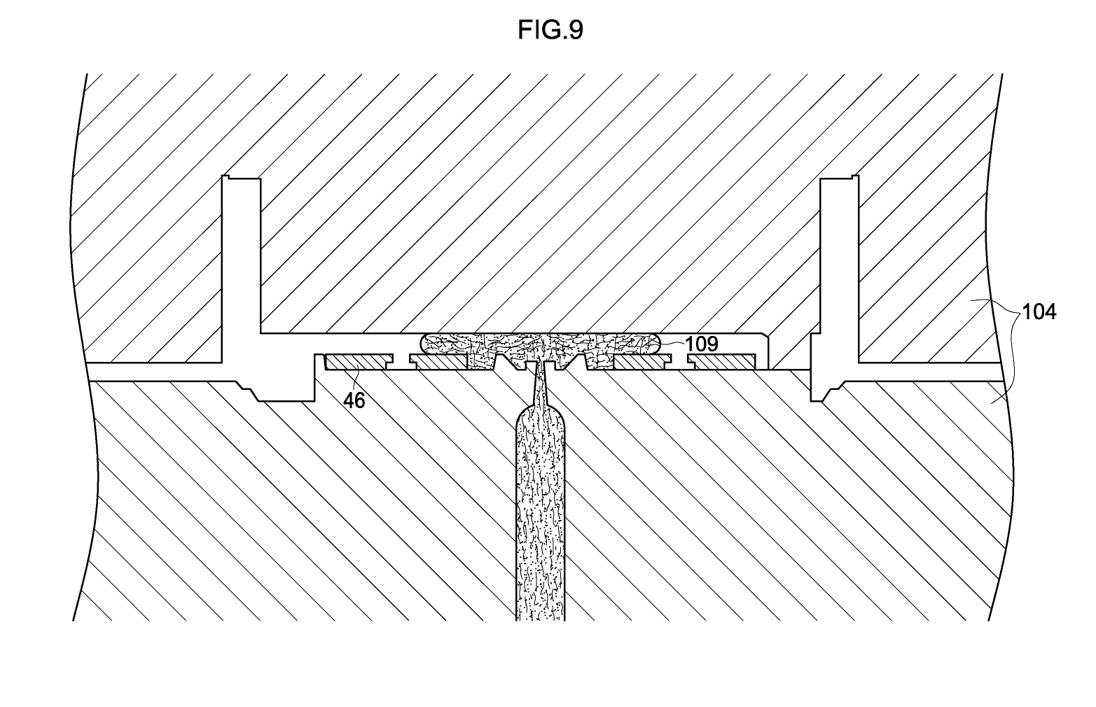

Therefore, it is possible that the length L2 of the conductive filler 108 is longer than the pellet length L1 of the resin pellet 106. In other words, a conductive filler 109 (see FIG. 9) has a length (e.g., approximately 1 mm) shorter than the pellet length L1 (L1=approximately 3 mm to 4 mm) of the resin pellet 106 in a case in which the conductive filler(s) is mixed into the resin pellet 106 in advance. In the manufacturing method of the reel 20 according to this exemplary embodiment, since the length L2 of the conductive filler 108 is not limited, the length L2 can be e.g., 5 mm or more.

Thus, while the conductivity provided to the reel 20 is secured, a flowability of the melted resin material in a mold (metal mold) 104 can be secured. In other words, in a case in which the conductive filler(s) is mixed into the resin pellet 106 in advance, the length of the conductive filler 109 is shorter than the pellet length L1 of the resin pellet 106, so that as shown in the comparative example of FIG. 9, the number (a mixing amount) of the conductive fillers 109 mixed into the melted resin material is increased, with the result that the flowability of the melted resin material in the mold 104 becomes worse by those conductive fillers 109.

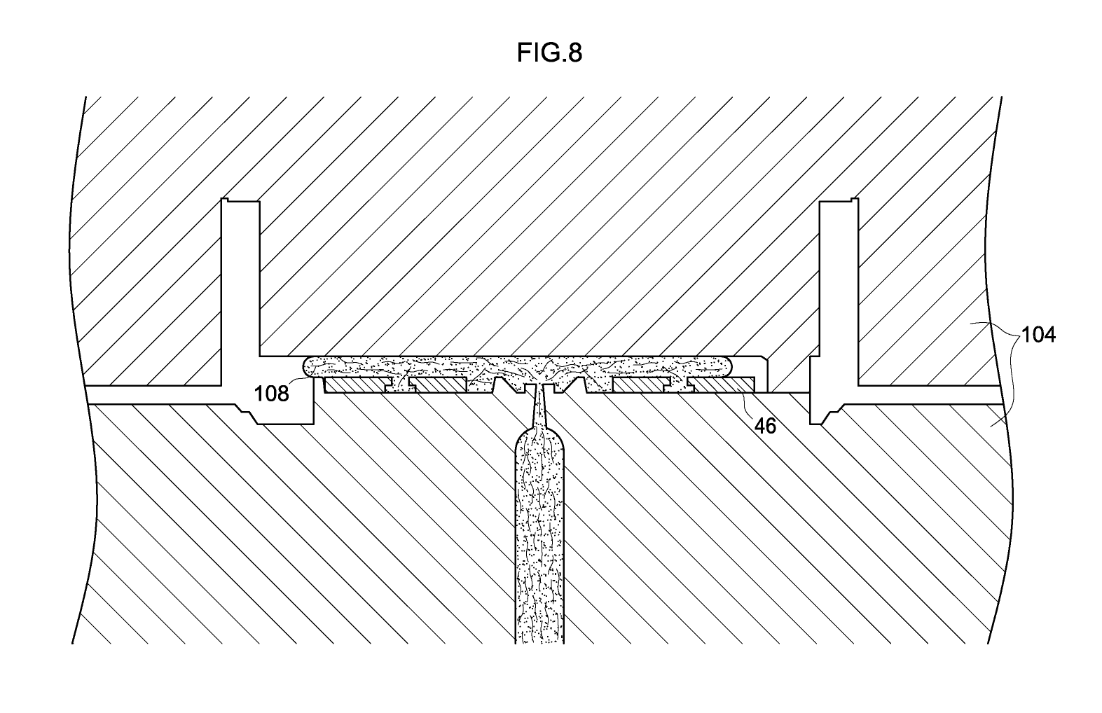

However, in the manufacturing method of the reel 20 according to this exemplary embodiment, the length L2 of the conductive filler 108 may be e.g., 6 mm, so that the number of the conductive fillers 108 mixed into the melted resin material can be smaller than the conventional art (the number of the conductive fillers 108 can be reduced to ⅙ or less in this case compared with a case in which the length of the conductive filler 109 is 1 mm). Therefore, as shown in FIG. 8, there is not the disadvantage such that the flowability of the melted resin material in the mold 104 becomes worse by the conductive fillers 108, and the flowability can be secured.

In other words, in the manufacturing method of the reel 20 according to this exemplary embodiment, with a lesser number of the conductive fillers 108, the same conductivity or more in a case in which the reel 20 is molded from the resin pellet (not shown) into which the conductive fillers with the number are mixed can be applied to the reel 20. Further, at the time of the molding, the flowability of the melted resin material can not be damaged by the conductive fillers 108. Therefore, the design of the mold 104 is not required to be changed, and the cost therefor can be eliminated.

Further, as the conductive filler 108, an alamido (aramid) fiber which is subject to copper plating is desirably used. Since the copper plated aramid fiber is a soft conductive filler (masterbatch), it is furthermore possible that the flowability of the melted resin material in the mold 104 does not become worse (the flowability can be sufficiently secured). Further, the copper plated aramid fiber (the conductive filler 108) has a strength in which the copper plated aramid fiber may not be cut even if kneaded (mixed) together with the resin pellet 106 in the injection molding machine 100, so that there is the merit that the length L2 can be reliably secured.

The manufacturing method of the reel 20 and the reel 20 and the recording tape cartridge 10 according to this exemplary embodiment have been described above, but the manufacturing method of the reel 20 and the reel 20 and the recording tape cartridge 10 according to this exemplary embodiment are not limited to the illustrated ones and the design may be changed, if necessary, within the range without departing from the purport of the invention. For example, the shape of the resin pellet 106 is not limited to the shown substantially cylindrical shape (elliptic cylindrical shape).

Also, it suffices that the recording tape T wound on the reel 20 is grasped as a long tape-like information recording/playback medium which may record information and play back the recorded information, and needless to say, the recording tape cartridge 10 which accommodates the reel 20 is applicable to the recording tape T of any recording/playback type.

What is claimed is:

1. A manufacturing method of a reel including a substantially cylindrical hub, around an outer peripheral surface of which a recording tape is wound, and flanges provided at end portions of the hub, the method comprising:
entering a pelletized resin material and a fibrous conductive material whose length is longer than a pellet length of the resin material into a molding machine to mold the hub and the flanges, thereby providing conductivity to the hub and the flanges.

2. The manufacturing method of a reel of claim 1, wherein as the conductive material, a copper plated aramid fiber is used.

3. The manufacturing method of a reel of claim 1, wherein the resin material entered into the molding machine does not contain therein a conductive material.

4. A reel that is manufactured by a manufacturing method of a reel including a substantially cylindrical hub, around an outer peripheral surface of which a recording tape is wound, and flanges provided at end portions of the hub, the method comprising entering a pelletized resin material and a fibrous conductive material whose length is longer than a pellet length of the resin material into a molding machine to mold the hub and the flanges, thereby providing conductivity to the hub and the flanges,
wherein a metal reel plate is fixed to an outer surface of a bottom portion of the hub.

5. The reel of claim 4, wherein the conductive material comprises a copper plated aramid fiber.

6. The reel of claim 4, wherein the resin material does not contain a conductive material.

7. A recording tape cartridge comprising:
a single reel on which a recording tape is wound, the reel being manufactured by a manufacturing method of a reel including a substantially cylindrical hub, around an outer peripheral surface of which the recording tape is wound, and flanges provided at end portions of the hub, the method comprising entering a pelletized resin material and a fibrous conductive material whose length is longer than a pellet length of the resin material into a molding machine to mold the hub and the flanges, thereby providing conductivity to the hub and the flanges, a metal reel plate being fixed to an outer surface of a bottom portion of the hub;
a case that accommodates the reel; and
a leader member that is attached to a free end portion of the recording tape and that is drawable out from an opening formed in the case.

8. The recording tape cartridge of claim 7, wherein the conductive material comprises a copper plated aramid fiber.

9. The recording tape cartridge of claim 7, wherein the resin material does not contain a conductive material.
